(19) United States
(12) Patent Application Publication
(10) Pub. No.: US 2007/0214658 A1
(43) Pub. Date: Sep. 20, 2007

(54) Triangular chain saw guide bar

(76) Inventors: Russell Payton, Rapid City, SD (US); Randall J. Daughenbaugh, Rapid City, SD (US)

Correspondence Address: Gene R. Woodle, 3516 Woodle Drive, Rapid City, SD, 57702, US

(21) Appl. No.: 11/724,466

(22) Filed: Mar. 15, 2007

Related U.S. Application Data
(60) Provisional application No. 60/783,517, filed on Mar. 16, 2006.

(51) Int. Cl. B23D 51/02

(52) U.S. Cl. 30/371

(57) ABSTRACT

A triangular chain saw guide bar is disclosed which may be used as a replacement for a conventional guide bar and which allows for cutting using a pushing rather than a swinging motion.

### RELATED APPLICATIONS

This application relies for priority upon the Provisional Patent Application filed by Russell H. Payton and Randall J. Daughenbaugh entitled Triangular Chain Saw Guide Bar with Improved Utility and Safety, Ser. No. 60/783,517, filed Mar. 16, 2006.

### BACKGROUND OF THE INVENTION

1. Field of the Invention

This invention relates generally to guide bars for chain saws, and more particularly to a triangular chain saw guide bar which allows the user to cut by pushing the saw away rather than pulling to one side or the other.

2. Background Information

Chain saws are used by thousands of people every day for a variety of purposes most often for cutting trees. Chain saws typically are either powered by internal combustion or electricity and usually include a power section with handle, a guide bar, and a continuous chain which is powered by the power section and runs continuously around the guide bar. The chain includes a plurality of cutting teeth which do the cutting. The guide bar is typically a long, flat plate with a rounded end and a slot which is parallel to the surface of the guide bar and runs around the circumference of the guide bar. On the opposite side of the chain from the cutting teeth are a plurality of teeth which ride in the slot in the guide bar and keep the chain in place around the circumference of the guide bar. The guide bar is ordinarily removably affixed to the power section such that the guide bar may be effectively lengthened or shortened in order to maintain the correct tension on the chain which has a tendency to lengthen through use.

When a conventional chain saw is normal operating position with the blade of the guide bar vertical, the chain runs away from the operator along the top of the guide bar and toward the operator along the bottom of the guide bar. With a conventional chain saw, the operator typically cuts using the section of the chain which is moving toward the operator. That is, using the portion of the moving chain which is on the bottom of the guide bar. A typical chain saw has two handles: a rearward handle which is parallel to the guide bar and a top handle which is perpendicular to the guide bar and forward of the rearward handle. The rearward handle usually includes a trigger with which the operator can control the speed of the rotation of the chain starting from zero. The operator typically uses both hand and both handles to operate the chain saw.

Operating a chain saw is an inherently dangerous activity, largely because almost the entire length of the chain is exposed. In addition, chain saws are often operated in outdoor, uncontrolled conditions with obstacles such as uneven ground and fallen trees. Another well known and dangerous aspect of chain saw operation is what is often known as “kickback.” Kickback is a violent, unintended jerk of the chain saw guide bar which can occur for a variety of reason such as hitting a rock or hard knot in the wood or cutting too close to the forward, rounded end of the guide bar. Kickback occurs is less than a tenth of a second and is the source of a high percentage of forestry accidents. Several attempts to create a chain saw configuration which reduces or eliminates kickback have been patented. A straightforward approach to the problem is to attach a guard to the guide bar which covers the top quadrant of the tip of the guide bar and prevents it from coming into contact with trees or other objects. The patent to Kesper (U.S. Pat. No. 5,035,057; Jul. 30, 1991), for instance, claims to eliminate kickback by changing the shape of the tip of the guide bar.

In many instances it is desirable to use a chain saw to cut using a pushing motion rather than the pulling motion most often used with a conventional chain saw. That is, to make a cut by pushing the forward end of the chain saw away from the operator rather than swinging the chain saw and cutting with the long edges of the guide bar. Using a conventional chain saw to make a push cut is both inefficient and dangerous for a variety of reasons. Perhaps the most commonly experienced of these reasons is the vastly increased chance of getting a kickback when using the tip of a conventional guide bar as a cutting surface. The device disclosed in the patent to Merle (U.S. Pat. No. 3,931,676; Jan. 13, 1976) is intended, at least in part, to allow for a push cut. A pair of legs are provided which may be affixed to a guide bar and extend forward beyond the tip of the guide bar. The two legs hold the tree or other object between them and, thus, prevent kickback further than the boundaries of the two legs.

The patent to Merle and the patent to Mattson et al. (U.S. Pat. No. 4,726,118; Feb. 23, 1988) illustrate another problem related to the use of a conventional chain saw: it is difficult and tiring to cut small trees and brush close to the ground for a variety of reasons. The cut must be made with the chain guide parallel to the ground and it is easiest to use a push cut. It is obvious that it would be difficult and tiring to hold a conventional chain saw at the level of the operator's feet using a conventional swing or pull cut. Merle attempts to solve the problem by letting the legs on the guide bar rest upon the ground. Mattson et al. attempts to solve the problem by providing a handle and skid assembly which may be affixed to a conventional chain saw. The skid rides on the ground and takes the weight of the chain saw and the handle extends upward such that the operator does not have to bend over.

The instant invention is a triangular chain saw guide bar which is unique, original, and solves all of the above noted problems relating to the use of a conventional chain saw. The triangular chain saw guide bar may be used as a replacement guide bar for a conventional chain saw.

The ideal triangular chain saw guide bar should provide for both cutting in a conventional swinging manner and for safely and efficiently cutting in a pushing manner. The ideal triangular chain saw guide bar should also be capable of being used with a conventional chain saw as a guide bar replacement. The idea triangular chain saw bar guide should also provide a guide bar that includes guards to prevent dangerous contact with portions of the chain, but still allow the cutting of trees and branches. The ideal triangular chain saw guide bar should also be capable of easily and efficiently cutting trees and brush off close to the ground. The ideal triangular chain saw guide bar should also be rugged, inexpensive, and easy to use.

### SUMMARY OF THE INVENTION

The triangular chain saw guide bar of the instant invention is intended to replace a conventional chain saw guide bar and may be used with a conventional chain saw and chain. The attachment portion of the instant invention is conventional and it may be affixed to a chain saw in the same manner as a conventional guide bar with the same provision for effectively shortening or lengthening the triangular chain saw guide bar to adjust chain tension.

The triangular chain saw guide bar is roughly triangular in shape and, generally, forms the shape of an isosceles triangle. The two equal length sides assume the function of the parallel sides of a conventional guide bar. The longitudinal axis of the triangular chain saw guide bar is assumed to be a line equidistant from these sides along the length of the triangular chain saw guide bar. The third side, the cutting side, is generally perpendicular to this longitudinal axis. Because centrifugal force tends to throw the chain away from the triangular chain saw guide bar, the corners where the equal sides meet the cutting side are rounded and the cutting side is also gently rounded outward from the interior of the triangular chain saw guide bar. A pair of rotating sprockets are supplied at the corners of the triangular chain saw guide bar to help hold the chain in place and move around the triangular chain saw guide bar more efficiently.

Because of the wide cutting side, an operator may safely and conveniently make push cuts using the cutting side of the triangular chain saw guide bar. The other sides of the triangular chain saw guide bar may still be used to make conventional swing cuts if desired.

In a second embodiment a pole attachment is provided. The pole attachment is affixed to a conventional chain saw power section at one end. The other end of the pole includes a guide attachment. The guide attachment includes a conventional chain saw power sprocket, a conventional chain oiler, and conventional means for affixing the triangular chain saw guide bar of the instant invention. Power is supplied to the chain saw power sprocket by means of a cable which runs through the pole attachment to the chain saw power section. A number of companies make a chain saw with a pole attachment which is often referred to as a “pole prunner.” Stihl (registered trademark), for instance, makes a pole prunner which is designated as an HT 100 Pole Prunner (Andreas Stihl AG and CO KG Corp, Badstrasse 115 71336, Wailblingen, Federal Republic of Germany). The Stihl Pole Prunner and other conventional pole prunners come with a conventional chain saw guide bar, but this guide bar can easily be replaced with the triangular chain saw guide bar of the instant invention.

In this second embodiment, the triangular chain saw guide bar may be used to cut trees and brush at ground level without bending over.

Both embodiments of the triangular chain saw guide of the instant invention may be equipped with guards which cover portions of the chain to prevent accidental contact and injury. Both embodiments of the triangular chain saw guide of the instant invention may also be equipped with tree guides which properly position the triangular chain saw guide in relation to the tree or other object to be cut.

One of the major objects of the present invention is to provide for both cutting in a conventional swinging manner and for safely and efficiently cutting in a pushing manner.

Another object of the present invention is to provide a guide bar capable of being used with a conventional chain saw as a guide bar replacement.

Another object of the present invention is to provide a guide bar capable of easily and efficiently cutting trees and brush off close to the ground

Another object of the present invention is to provide a guide bar that includes guards to prevent dangerous contact with portions of the chain, but still allow the cutting of trees and branches.

Another object of the present invention is to a triangular chain saw guide bar which is rugged, inexpensive, and easy to use.

These and other features of the invention will become apparent when taken in consideration with the following detailed description and the drawings.

### BRIEF DESCRIPTION OF THE DRAWINGS

FIG. 1 is a side view of a typical conventional chain saw with a conventional guide bar;

FIG. 2 is a side view of a triangular chain saw guide bar of the instant invention with certain sections cut away to show interior detail;

FIG. 3 is a side view of a triangular chain saw guide bar with a first embodiment of a guard and tree guide;

FIG. 4 is a side view of a triangular chain saw guide bar with a second embodiment of a guard and tree guide;

FIG. 5 illustrates the dangerous kickback zone of a conventional chain saw; and

FIG. 6 illustrates the dangerous kickback zone of the instant invention.

### DESCRIPTION OF A PREFERRED EMBODIMENT

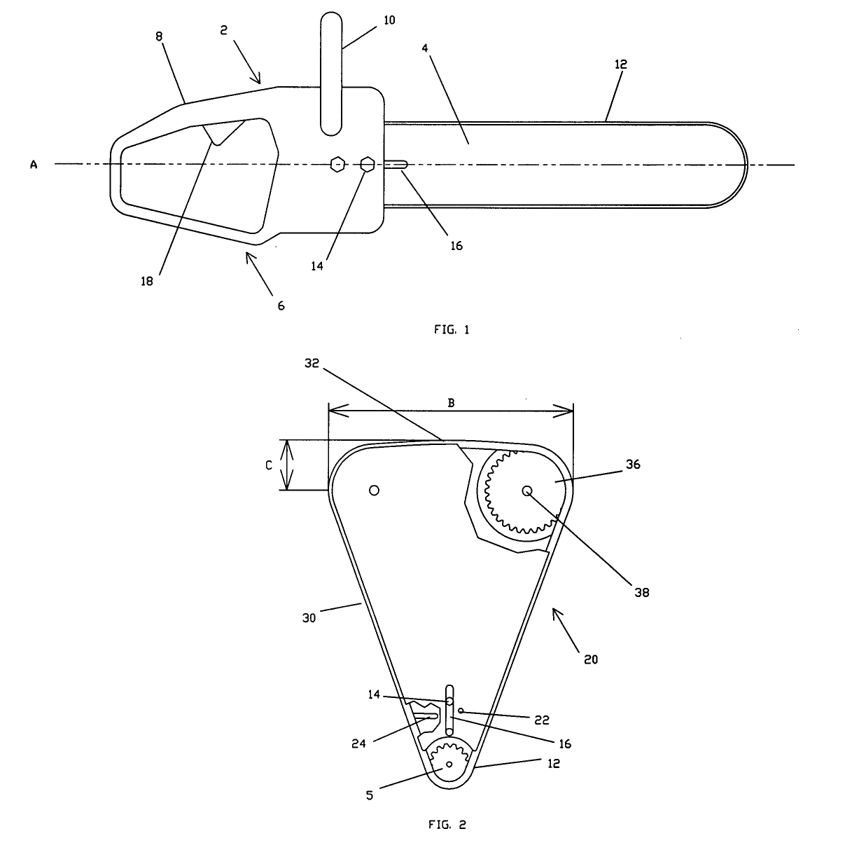

Referring to the drawings, FIGS. 1 through 4, a conventional chain saw and various versions of the triangular chain saw guide bar of the instant invention are shown. The conventional chain saw and guide bar are not considered part of the invention. The triangular chain saw guide bar is made to be a replacement for the conventional guide bar and used with a conventional chain saw.

Referring to the drawing FIG. 1, a conventional chain saw 2 with a conventional guide bar 4 is shown. The power section 6 of the chain saw 2 includes either an internal combustion engine or an electric motor to power said chain saw 2. The power section 6 usually includes a rearward handle 8 and a forward handle 10. The guide bar 4 has a guide slot (not shown) around its circumference and a chain 12 has guide teeth (not shown) which ride around the guide slot in said guide bar 4. Cutting teeth (not shown) protrude outward from the chain 12. Mounting bolts 14 may be tightened to hold said guide bar 4 firmly in place within said power section 6. Said chain 12 has a tendency to lengthen with use. Said guide bar 4 includes a positioning slot 16. After loosening the mounting bolts 14, said guide bar 4 may be moved forward or backward along the positioning slot 16 to maintain the proper tension on said chain 12 and said mounting bolts 14 tightened to hold said guide bar 4 in the proper position. A power sprocket 5 (not shown) within said power section 6 engages said chain 12 and propels said chain 12 around said guide bar 4. A trigger 18 controls power to the power sprocket 5 and, thus, the speed of said chain 12. Phantom line A is considered the longitudinal axis of said chain saw 2. Said power section 6 is considered to be at the rearward end of said chain saw 2 and said guide bar 4 is considered to be at the forward end of said chain saw 2.

Referring now to FIG. 2, a side view of a triangular chain saw guide bar of the instant invention with certain sections cut away to show interior detail is shown. The triangular chain saw guide bar 20 includes all of the elements of a conventional chain saw guide bar 4 (see FIG. 1) including said positioning slot 16, a chain tensioning hole 22, and an oil supply groove 24. These elements (said positioning slot 16, the chain tensioning hole 22, and the oil supply groove 24) work in the same manner as comparable elements in said conventional chain saw guide bar 4 and will not be explained in detail here. Said chain 12 is the same as is used in said conventional chain saw 2. The triangular chain saw guide bar 20 is affixed to said power section 6 and adjusted using said mounting bolts 14 in exactly the same manner as said guide bar 4. However, rather than having parallel sides and a circular tip like said guide bar 4, said triangular chain saw guide bar 20 has the general shape of an isosceles triangle with two equal sides 30 replacing the parallel sides of said guide bar 4 and a cutting side 32 replacing the circular end of said guide bar 4. The power sprocket 5 of said power section 6 (not shown in this Figure) drives said chain 12 around said triangular chain saw guide bar 20 in exactly the same manner as said chain 12 is driven around said guide bar 4 in a conventional chain saw. Two sprockets 36, located at the two points where the two sides 30 meet the cutting side 32, rotate about a pair of sprocket pins 38 and have teeth which engage said chain 12. The sprockets 36 serve to hold said chain 12 in position within said triangular chain saw guide bar 20 and act to reduce friction between said chain 12 and said triangular chain saw guide bar 20. It should be understood that the triangular chain saw guide bar 20 could be made in a variety of shapes including an isosceles triangle or an equilateral triangle.

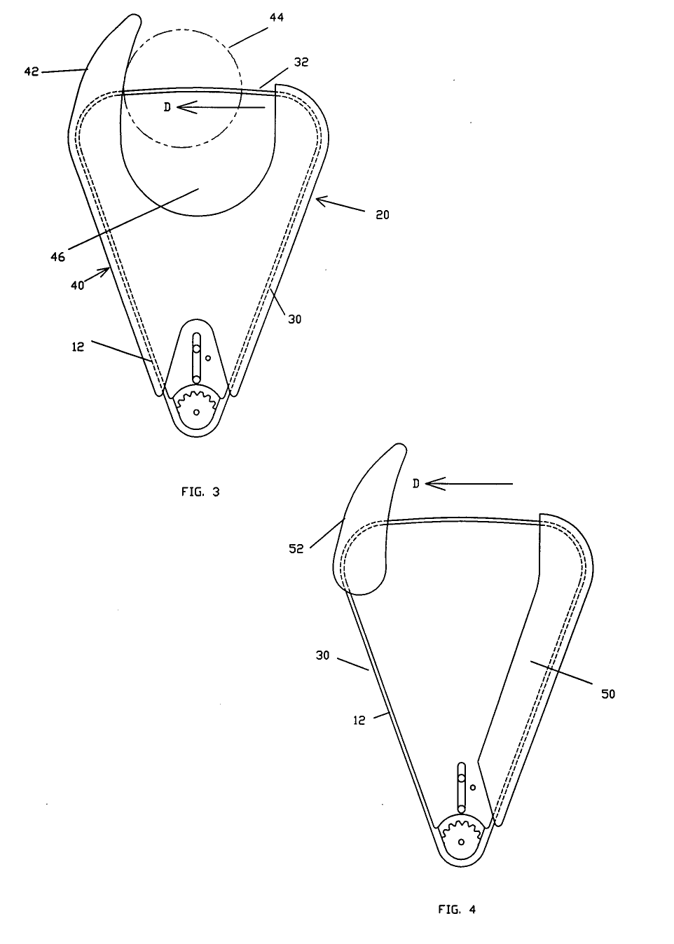

Now referring to FIG. 3, a side view of a triangular chain saw guide bar with a first embodiment of a guard and tree guide is shown. Said triangular chain saw guide bar 20 of the instant invention is as previously described. A first guard 40 is affixed to each side said triangular chain saw guide bar 20 by means of bolts. The first guard 40 generally follows the perimeter of said triangular chain saw guide bar 20, but is slightly larger such that it protrudes a half inch outward from said triangular chain saw guide bar 20 such that said chain 12 is covered on the two sides 30. Said first guard 40 makes said chain saw 2 (not shown in this Figure) much safer, because it greatly reduces the chances of an operator accidentally cutting himself on the portions of said chain 12 running along said sides 30. The arrow D indicates the direction of travel of said chain 12 around the perimeter of said triangular chain saw guide bar 20. A tree guide 42 protrudes forward from one of said sides 30 such that said chain 12 travels toward the tree guide 42 along said cutting side 32. When said cutting side 32 is used to cut, for instance, a tree 44, said cutting side 32 is positioned such that it contacts the tree 44 and said tree 44 contacts said tree guide 42. This acts to keep said cutting side 32 in proper position relative to said tree 44 and provides for safe and efficient cutting. Said first guard 40 includes an opening 46 which protrudes rearward from said cutting side 32. This allows that portion of said tree 44 or similar articles which has been cut to move rearward of said cutting side 32.

Now referring to FIG. 4, a side view of a triangular chain saw guide bar with a second embodiment of a guard and tree guide is shown. This embodiment serves the same function and is basically the same as said first guard 40 and said tree guide 42 described above except that one of said sides 30 is exposed and the portion of said chain 12 which moves rearward toward the operator is exposed. A second guard 50 covers the other of said sides 30 and a second tree guide 52 is the same as said tree guard 42. In this embodiment an operator can make cuts both parallel to the longitudinal axis of said chain saw 2 as with a conventional chain saw guide bar 4 and perpendicular to the longitudinal axis using said cutting side 32.

Now referring to FIG. 5, an illustration of the dangerous kickback zone of a conventional chain saw is shown. A conventional chain saw bar guide 60 is shown with the arrow E showing the direction of travel of the chain. According to a variety of sources including the University of California (LeBlanc, J. Using a Chain Saw Safely, University of California Cooperative Extension) and the Canadian Center for Occupational Health and Safety, the area of a bar guide which is most dangerous for kickback is illustrated by shaded area 64. Objects 66 illustrate the position of objects where contact between the objects and the shaded area 64 should be avoided. An examination of FIG. 5 indicates that dangerous kickback is most likely to occur at points where the chain may be pinched or caught in the object contacted where the chain will be forced back through the object in a direction opposite the direction of the travel of the chain around the guide bar 60. That is, in the opposite direction of arrow 62. Point 68 represents the approximate location of the center of gravity of a chain saw with said guide bar 60 attached. Arc 70 represents a portion of a circle drawn with its center at point 68 and its radius equal to the distance between said point 68 and the point on said guide bar 60 which is furthest from said point 68 which is designated as end point 72.

Still referring to FIG. 5, the arc 70 can be said to approximate what will be referred to as a no kickback arc. As may be seen from examination of FIG. 5, if the end of said bar guide 60 followed said arc 70; it would be unlikely that kickback would occur, because said bar guide 60 would not be forced through any object which it contacted along said arc 70. That is, if the tip of said guide bar 60 had a radius as large or larger than said arc 70 it would be significantly less likely for kickback to occur than if the radius of the tip were smaller than the radius of said arc 70.

Referring again to FIG. 2, said cutting side 32 curves gently outward from the interior of said triangular chain saw guide bar 20. Said chain 12 moves rapidly around said triangular chain saw guide bar 20 and the forces acting upon said chain 12 tend to throw said chain 12 away from said cutting side 32. The curve in said cutting side 32 acts to keep said chain 12 in contact with said cutting side 32 and the riding teeth of said chain 12 within the chain slot (not shown) around the circumference of said triangular chain saw guide bar 20. (The chain slot is the same as the chain slot around the perimeter of said conventional guide bar 4.) Dimension B represents the width of the widest measurement of said triangular chain saw guide bar 20. Dimension C measures the extent of the curvature of said cutting side 32. Dimension C measures the shortest distance between the forward most point of said cutting side 32 and a line connecting the two points which define the widest point of said triangular chain saw guide bar 20. In the preferred embodiment of said triangular chain saw guide bar 20 the ratio of C/B equals 0.1. However, the invention will still work properly as long as this ratio is less than 0.2. This ratio is intended to approximate the no kickback arc referenced above and, if this ratio is larger than 0.2, the danger of kickback incidents increases significantly.

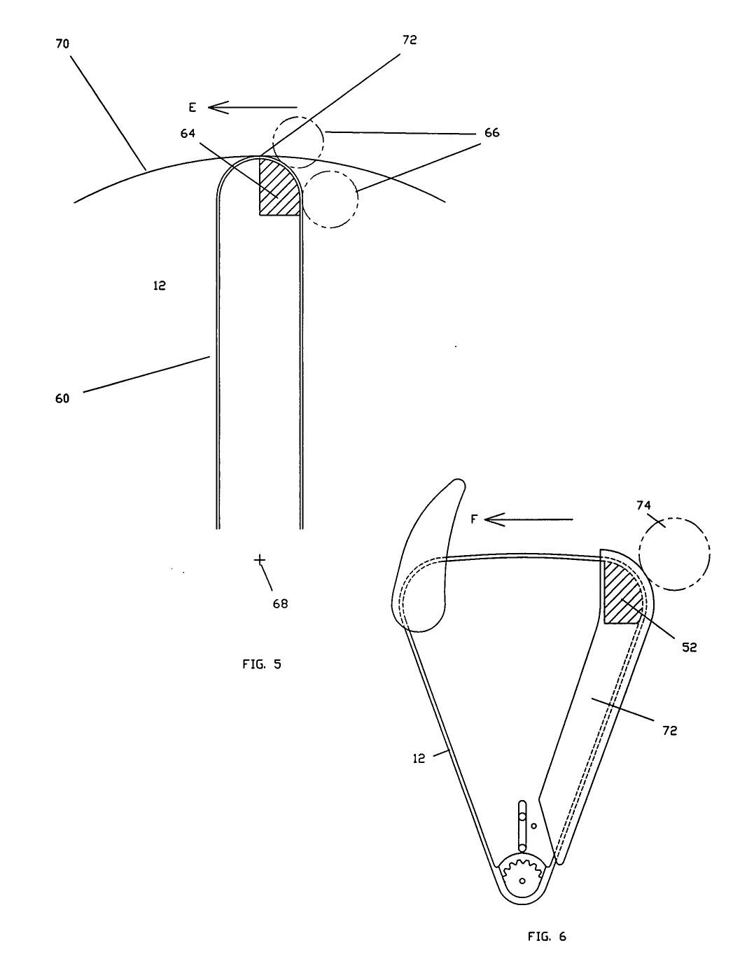

Referring now to FIG. 6, an illustration of the dangerous kickback zone of the instant invention is shown. In this Figure, the embodiment of the triangular chain saw guide bar with a guard as in FIG. 4 is illustrated. The arrow F shows the direction of travel of said chain 12. An instant shaded area 70 is shown which approximates the same dangerous kickback zone as is depicted by shaded area 64 in a conventional chain saw in FIG. 5. A lower guard 72 completely covers the instant shaded area 70 in this embodiment and prevents any objects 74 from coming into contact with the dangerous kickback zone. Even if the lower guard 72 were not present, it can be seen by a comparison of FIG. 6 with FIG. 5 that about half of the area of the tip of a conventional chain saw is a safe area and about four fifths of the area of the tip of the triangular chain saw guide bar of the instant invention is a safe area.

A number of companies including Stihl (registered trademark) make what is often known as a pole prunner. A pole prunner has a relatively long pole interposed between the power section of a chain saw and the guide bar and chain section. Power conducting means connects the power section to a drive sprocket in the guide bar and chain section. The guide bar and chain operate in the same manner as with a conventional chain, but the operator has a much greater reach. A conventional chain saw guide bar is used. Said triangular chain saw guide bar and all of its embodiments described above could, without modification be used as a replacement for the conventional guide bar.

In operation, said chain saw guide bar 20 operates in exactly the same manner as a conventional guide bar except that the cutting motion is different. With a conventional guide bar cuts are almost always made using a swinging motion. That is, said chain 12 is moved in a direction which is perpendicular to the longitudinal axis of the chain saw. With said chain saw guide bar 20 of the instant invention, cutting is accomplished by moving said cutting side 32 in a direction which is parallel to the longitudinal axis of the chain saw. That is, the operator cuts by pushing the chain saw away from the operator. With a standing tree, for example, this pushing action is thought to be much more natural and less tiring than the conventional swinging motion. Cutting using a pushing motion is also safer, because the cutting action takes place further away from the operator at the end of the guide bar rather than along the length of the guide bar. Cutting with a pushing motion using a conventional guide bar is possible, but the chances of kickback occurring increase dramatically.

In the preferred embodiment of the instant invention, all parts and elements are made from steel except for said tree guides 42 and 52 and said guards 40 and 50 which are made from aluminum. Said chain 12 is a standard, conventional chain saw chain. Other materials having similar weight, strength, and durability characteristics could be used.

While preferred embodiments of this invention have been shown and described above, it will be apparent to those skilled in the art that various modifications may be made in these embodiments without departing from the spirit of the present invention.

We claim:

1. A chain saw guide bar to be used with a conventional chain saw as a replacement for a conventional guide bar in which the chain saw has a rearward end toward the power section and a forward end toward the guide bar and a longitudinal axis which runs from the rearward end to the forward end and the chain saw having a cutting chain, comprising:
a chain saw guide bar having a flat forward cutting edge such that with the chain saw guide bar and the chain in place the chain saw may be used to cut by moving the forward cutting edge parallel to the longitudinal axis of the chain saw;
whereby, an operator may cut using the chain saw with a pushing motion rather than by swinging the chain saw perpendicular to the longitudinal axis of the chain saw.

2. The chain saw guide bar of claim 1 in which the flat forward cutting edge is curved forward to form a curved forward cutting edge and in which an imaginary width line may be drawn across the widest portion of said chain saw guide bar and an imaginary tip line drawn from the width line to the forwardmost point on the tip of said chain saw guide bar and the ratio of the length of shortest possible tip line to the length of the width line is less than 0.2.

3. The chain saw guide bar of claim 1 in which the chain rides on a pair of sprockets with teeth located at the ends of said flat forward cutting edge.

4. The chain saw guide bar of claim 2 in which the chain rides on a pair of sprockets with teeth located at the ends of curved forward cutting edge.

5. The chain saw guide bar of claim 1 in which a tree guide protrudes forward from one end of said flat forward cutting edge such that the chain travels along said flat forward cutting edge toward the tree guide.

6. The chain saw guide bar of claim 2 in which a tree guide protrudes forward from one end of said curved forward cutting edge such that the chain travels along said curved forward cutting edge toward the tree guide.

7. The chain saw guide bar of claim 3 in which a tree guide protrudes forward from one end of said flat forward cutting edge such that the chain travels along said flat forward cutting edge toward the tree guide.

8. The chain saw guide bar of claim 4 in which in which a tree guide protrudes forward from one end of said curved forward cutting edge such that the chain travels along said curved forward cutting edge toward the tree guide.

9. A chain saw guide bar to be used with a conventional chain saw as a replacement for a conventional guide bar in which the chain saw has a rearward end toward the power section and a forward end toward the guide bar and a longitudinal axis which runs from the rearward end to the forward end and the chain saw having a cutting chain, comprising:
(1) a chain saw guide bar having a flat forward cutting edge such that with the chain saw guide bar and the chain in place the chain saw may be used to cut by moving the forward cutting edge parallel to the longitudinal axis of the chain saw; and
(2) a guard affixed to said chain saw guide bar which protrudes outward from said chain saw guide bar a sufficient distance to prevent contact with the portions of the chain not located at said flat forward cutting edge and the guard having an opening rearward from said flat forward cutting edge such that trees or other objects being cut may pass rearward from said flat forward cutting edge;
whereby, an operator may cut using the chain saw with a pushing motion rather than by swinging the chain saw perpendicular to the longitudinal axis of the chain saw and contact with the portions of the chain not located at said flat forward cutting edge is prevented by said guard.

10. The chain saw guide bar of claim 9 in which the flat forward cutting edge is curved forward to form a curved forward cutting edge and in which an imaginary width line may be drawn across the widest portion of said chain saw guide bar and an imaginary tip line drawn from the width line to the forwardmost point on the tip of said chain saw guide bar and the ratio of the length of shortest possible tip line to the length of the width line is less than 0.2.

11. The chain saw guide bar of claim 9 in which the chain rides on a pair of sprockets with teeth located at the ends of said flat forward cutting edge.

12. The chain saw guide bar of claim 10 in which the chain rides on a pair of sprockets with teeth located at the ends of curved forward cutting edge.

13. The chain saw guide bar of claim 9 in which a tree guide protrudes forward from one end of said flat forward cutting edge such that the chain travels along said flat forward cutting edge toward the tree guide.

14. The chain saw guide bar of claim 10 in which a tree guide protrudes forward from one end of said curved forward cutting edge such that the chain travels along said curved forward cutting edge toward the tree guide.

15. The chain saw guide bar of claim 11 in which a tree guide protrudes forward from one end of said flat forward cutting edge such that the chain travels along said flat forward cutting edge toward the tree guide.

16. The chain saw guide bar of claim 12 in which in which a tree guide protrudes forward from one end of said curved forward cutting edge such that the chain travels along said curved forward cutting edge toward the tree guide.

17. A chain saw guide bar to be used with a conventional chain saw as a replacement for a conventional guide bar in which the chain saw has a rearward end toward the power section and a forward end toward the guide bar and a longitudinal axis which runs from the rearward end to the forward end and the chain saw having a cutting chain, comprising:
(1) a chain saw guide bar having a flat forward cutting edge such that with the chain saw guide bar and the chain in place the chain saw may be used to cut by moving the forward cutting edge parallel to the longitudinal axis of the chain saw; and
(2) a guard affixed to said chain saw guide bar which protrudes outward from said chain saw guide bar a sufficient distance to prevent contact with the portions of the chain not located at said flat forward cutting edge and not located on the side of said chain saw guide bar where the chain returns to the chain saw and the guard having an opening rearward from said flat forward cutting edge such that trees or other objects being cut may pass rearward from said flat forward cutting edge;
whereby, an operator may cut using the chain saw with a pushing motion rather than by swinging the chain saw perpendicular to the longitudinal axis of the chain saw and contact with the portions of the chain not located at said flat forward cutting edge is prevented by said guard.

18. The chain saw guide bar of claim 17 in which the flat forward cutting edge is curved forward to form a curved forward cutting edge and in which an imaginary width line may be drawn across the widest portion of said chain saw guide bar and an imaginary tip line drawn from the width line to the forwardmost point on the tip of said chain saw guide bar and the ratio of the length of shortest possible tip line to the length of the width line is less than 0.2.

19. The chain saw guide bar of claim 17 in which the chain rides on a pair of sprockets with teeth located at the ends of said flat forward cutting edge.

20. The chain saw guide bar of claim 18 in which the chain rides on a pair of sprockets with teeth located at the ends of curved forward cutting edge.

21. The chain saw guide bar of claim 17 in which a tree guide protrudes forward from one end of said flat forward cutting edge such that the chain travels along said flat forward cutting edge toward the tree guide.

22. The chain saw guide bar of claim 18 in which a tree guide protrudes forward from one end of said curved forward cutting edge such that the chain travels along said curved forward cutting edge toward the tree guide.

23. The chain saw guide bar of claim 19 in which a tree guide protrudes forward from one end of said flat forward cutting edge such that the chain travels along said flat forward cutting edge toward the tree guide.

24. The chain saw guide bar of claim 20 in which in which a tree guide protrudes forward from one end of said curved forward cutting edge such that the chain travels along said curved forward cutting edge toward the tree guide.
